(19) United States
(12) Patent Application Publication
(10) Pub. No.: US 2014/0172574 A1
(43) Pub. Date: Jun. 19, 2014

(54) INFORMATION TRANSMISSION DEVICE, INFORMATION TRANSMISSION METHOD, AND NON-TRANSITORY COMPUTER-READABLE RECORDING MEDIUM

(71) Applicant: YAHOO JAPAN CORPORATION, Tokyo (JP)

(72) Inventor: Takamitsu IRIYAMA, Tokyo (JP)

(73) Assignee: YAHOO JAPAN CORPORATION, Tokyo (JP)

(21) Appl. No.: 14/105,764

(22) Filed: Dec. 13, 2013

(30) Foreign Application Priority Data
Dec. 18, 2012 (JP) 2012-275840

(51) Int. Cl. G06Q 30/02

(52) U.S. Cl. CPC G06Q 30/0261
USPC 705/14.58

(57) ABSTRACT

An information transmission device stores attribute information of each product to be provided to a user. The information transmission device acquires positional information of the user from a communication device owned by the user. The information transmission device specifies the user's situation using at least the acquired positional information of the user. The information transmission device specifies the product having the user's specified situation as the attribute information. The information transmission device transmits the specified product to the communication device.

### CROSS-REFERENCE TO RELATED APPLICATIONS

The present application claims priority to and incorporates by reference the entire contents of Japanese Patent Application No. 2012-275840 filed in Japan on Dec. 18, 2012.

### BACKGROUND OF THE INVENTION

1. Field of the Invention

The present invention relates to an information transmission device, an information transmission method, and an information transmission program.

2. Description of the Related Art

In recent years, as smartphones have been widely used and a public wireless local area network (LAN) has increased in speed, users can access the Internet anywhere. As the number of accessing users increases, companies are striving to be distinguished from other companies by providing users with useful advertisements or the like.

For example, known is a technique in which a store such as a restaurant registers a daily special menu, lunch information, or the like in advance, and induces the user to input a search condition when the user makes an access thereto through a smartphone, and then the store transmits a menu matching the input search condition to the smartphone of the user in order to encourage the user to visit the store (see, for example, JP 2003-208432 A and JP 2004-265294 A).

However, in the technique according to the related art, a side providing information such as a menu hardly provides information desired by the user if the user does neither make an access nor input the search condition. Thus, information is not sufficiently provided and is insufficient to encourage the user to use the service. Further, a technique of registering user information to the store side and providing service information corresponding to the registered information from the store side directly to the user is considered, but registering individual information to the store side is undesirable in terms of security.

### SUMMARY OF THE INVENTION

According to the information transmission device, the information transmission method, and the information transmission program of the present disclosure, an effect capable of efficiently providing information desired by the user is obtained.

### BRIEF DESCRIPTION OF THE DRAWINGS

FIG. 1 is a diagram illustrating an exemplary overall configuration of a system according to a first embodiment;

FIG. 2 is a functional block diagram illustrating a functional configuration of an information transmission device according to the first embodiment;

FIG. 3 is a diagram illustrating exemplary information stored in a user information DB;

FIG. 4 is a diagram illustrating exemplary information stored in a menu DB;

FIG. 5 is a flowchart illustrating the flow of a coupon issuing process performed by the information transmission device according to the first embodiment;

FIG. 6 is a diagram for describing of a concrete example of matching;

FIG. 7 is a diagram for describing processing of an information transmission device according to a second embodiment;

FIG. 8 is a diagram for describing processing of an information transmission device according to a third embodiment;

FIG. 9 is a diagram for describing a first exemplary matching process; and

FIG. 10 is a diagram for describing a second exemplary matching process.

### DETAILED DESCRIPTION OF THE PREFERRED EMBODIMENTS

Hereinafter, exemplary embodiments of an information transmission device, an information transmission method, and an information transmission program according to the present disclosure will be described in detail with reference to the appended drawings. The invention is not limited to the following embodiments.

### First Embodiment

### 1. System Configuration

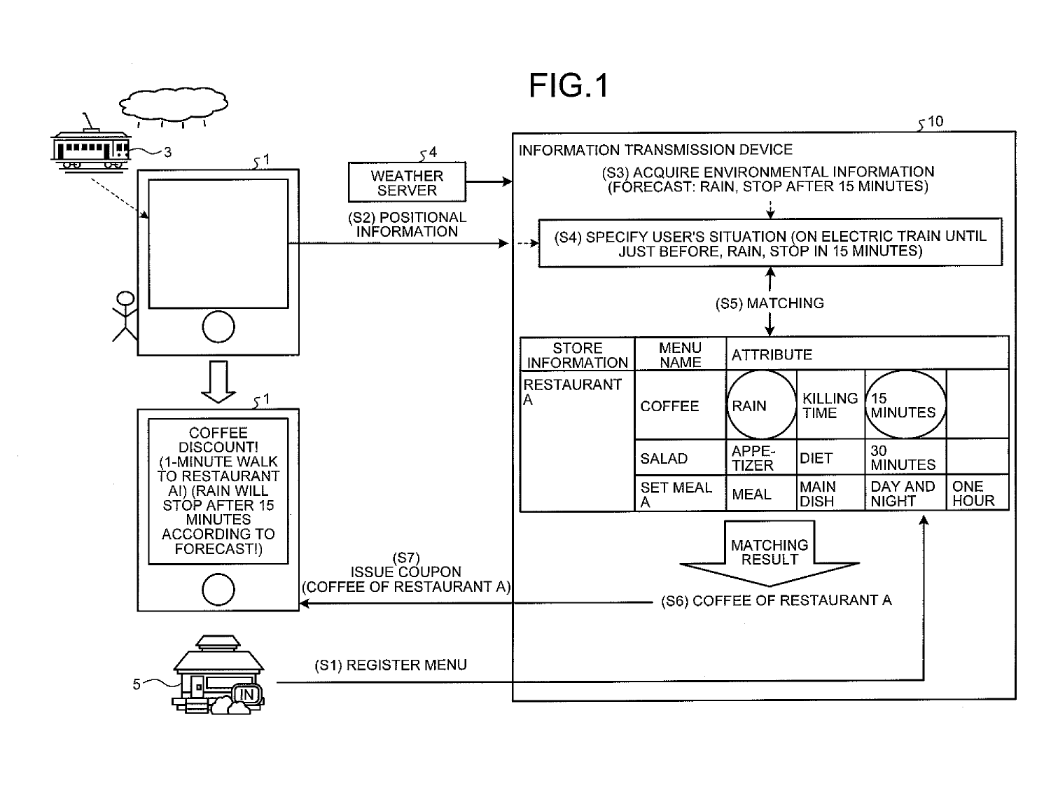

First of all, an overall configuration of a system according to a first embodiment will be described. FIG. 1 is a diagram illustrating an exemplary overall configuration of the system according to the first embodiment. The system includes a terminal device 1, a store 5, and an information transmission device 10, and in this system, the information transmission device 10 provides the terminal device 1 with information such as a coupon as illustrated in FIG. 1.

The terminal device 1 is an example of a mobile phone or a smartphone of the user, and performs communication with the information transmission device 10 via a network such as the Internet. Further, the terminal device 1 is of a registered user who has been registered to the information transmission device 10, and transmits positional information to the information transmission device 10 at regular intervals.

The store 5 is an example of a service providing side that provides the user with information, and performs communication with the information transmission device 10 via a network such as the Internet. Further, the store 5 registers a menu of foods or beverages to be provided to the user and an attribute of the corresponding menu to the information transmission device 10. The store 5 registers a menu or an attribute at any time when a menu is changed or when an attribute is changed.

The information transmission device 10 is an example of a server device that provides the user with a coupon or the like. The information transmission device 10 stores information related to the registered user. For example, the information transmission device 10 stores a name, a user ID, an address, a telephone number, an e-mail address, a sex, and an age of the user as user information.

In this state, the information transmission device 10 receives a menu and an attribute of the menu from the store 5, and registers the menu and the attribute to a menu DB (S1). For example, the information transmission device 10 stores “restaurant A, coffee, rain/killing time/15 minutes” as “store information, menu name, attribute.” Further, the information transmission device 10 stores “restaurant A, salad, appetizer/diet/30 minutes” as “store information, menu name, attribute.” Similarly, the information transmission device 10 stores “restaurant A, set meal A, meal/main dish/day and night/one hour” as “store information, menu name, attribute.” The store 5 can freely set an attribute to a menu.

Then, the information transmission device 10 acquires positional information from the terminal device 1 (S2). Further, the information transmission device 10 acquires environmental information corresponding to the positional information from an external weather server 4 or the like at a timing at which the positional information is acquired (S3). Here, an example of the acquired positional information is an address or the like, and an example of the environmental information is a weather forecast such as “rain, stop in 15 minutes” or the like.

Then, the information transmission device 10 specifies the user's situation using at least the user's positional information (S4). Specifically, the information transmission device 10 acquires the address or the like as the positional information, and specifies the user's situation using previous positional information and an acquisition time thereof, current positional information and an acquisition time thereof, and the environmental information. For example, when the address representing the user's previously acquired position is a railway track of an electric train, and it is specified that the user has moved 2 km during 5 minutes based on a moving distance and a moving period of time from the previous time to the current time, the information transmission device 10 specifies that the user had been on an electric train 3 until just before the current positional information was acquired. Further, the information transmission device 10 specifies that the user got off from the electric train 3 since the current positional information represents a position around a station. Thus, the information transmission device 10 specifies “on electric train until just before, rain, stop in 15 minutes” as the situations of the user of the terminal device 1.

Then, the information transmission device 10 performs matching of the user's situation and the menu information (S5), and specifies provision information having the user's situation as the attribute with reference to the menu DB (S6). For example, the information transmission device 10 extracts “electric train, rain, 15 minutes” as the attributes based on the user's specified situations “on electric train until just before, rain, stop in 15 minutes.” Then, the information transmission device 10 specifies that there is no menu associated with the attribute “electric train,” a menu associated with the attribute “rain” is “coffee,” and a menu associated with the attribute “15 minutes” is “coffee” with reference to the menu DB. As a result, the information transmission device 10 specifies “coffee of restaurant A” as a menu corresponding to the user's situations “on electric train until just before, rain, stop in 15 minutes.”

Thereafter, the information transmission device 10 delivers, i.e., transmits information of the specified menu to the terminal device 1 (S7). For example, the information transmission device 10 delivers a coupon of “coffee of restaurant A” specified in S5 to the terminal device 1 via an e-mail. At this time, the information transmission device 10 delivers, for example, “One minute to restaurant A by walk!” and “Rain will stop in 15 minutes according to forecast!” as a required time taken to get to the restaurant A from the user's current position and a weather forecast acquired from the weather server 4 together with the coupon. Then, the terminal device 1 displays the delivered coupon on a screen in the form of a banner or a dialogue.

As a result, the terminal device 1 can automatically acquire a useful coupon corresponding to the current situation. Further, the information transmission device 10 can encourage the user to use a coupon by notifying of a weather forecast, a required time, or the like together. As described above, the information transmission device 10 can efficiently provide information desired by the user.

Further, when a coupon is delivered or when a delivered coupon is actually used, the information transmission device 10 may bill the store 5, and thus it is possible to efficiently bill and construct a useful business model. Further, it may be determined whether a coupon has been actually used, for example, based on whether the terminal device 1 has transmitted a coupon to the store 5 using a coupon application or a near field communication (NFC).

### 2. Configuration of Information Transmission Device

Next, a functional configuration of the information transmission device will be described. The terminal device 1 has a functional configuration similar to that of a common smartphone, and the store 5 and the weather server 4 have a functional configuration similar to that of a common server, and thus a detailed description thereof will not be provided.

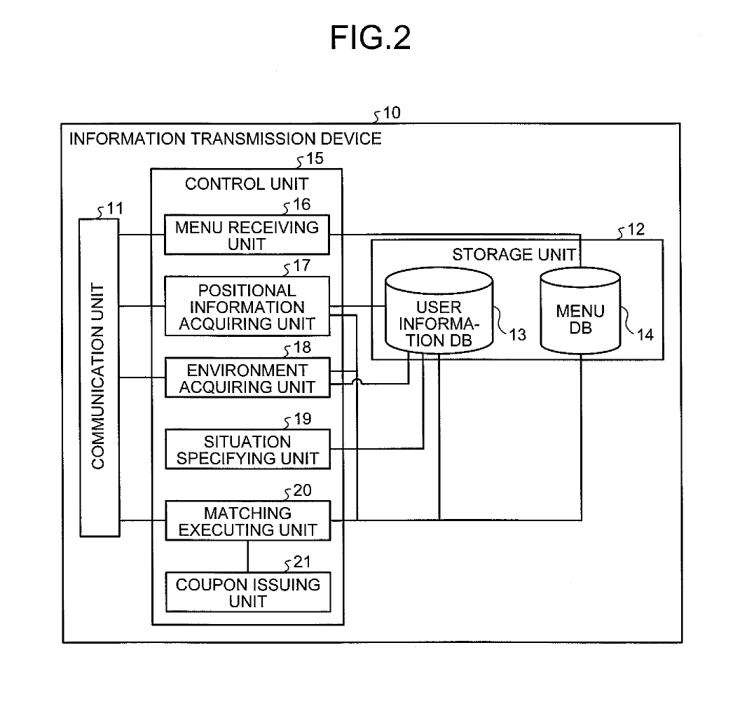

FIG. 2 is a functional block diagram illustrating a functional configuration of the information transmission device according to the first embodiment. The information transmission device 10 includes a communication unit 11, a storage unit 12, and a control unit 15 as illustrated in FIG. 2.

The communication unit 11 is a network interface card (NIC) or a wireless communication interface. The communication unit 11 establishes communication with the store 5 and receives the menu information. The communication unit 11 delivers a coupon to the terminal device 1. The communication unit 11 receives the positional information from the terminal device 1, and receives the weather forecast from the weather server 4.

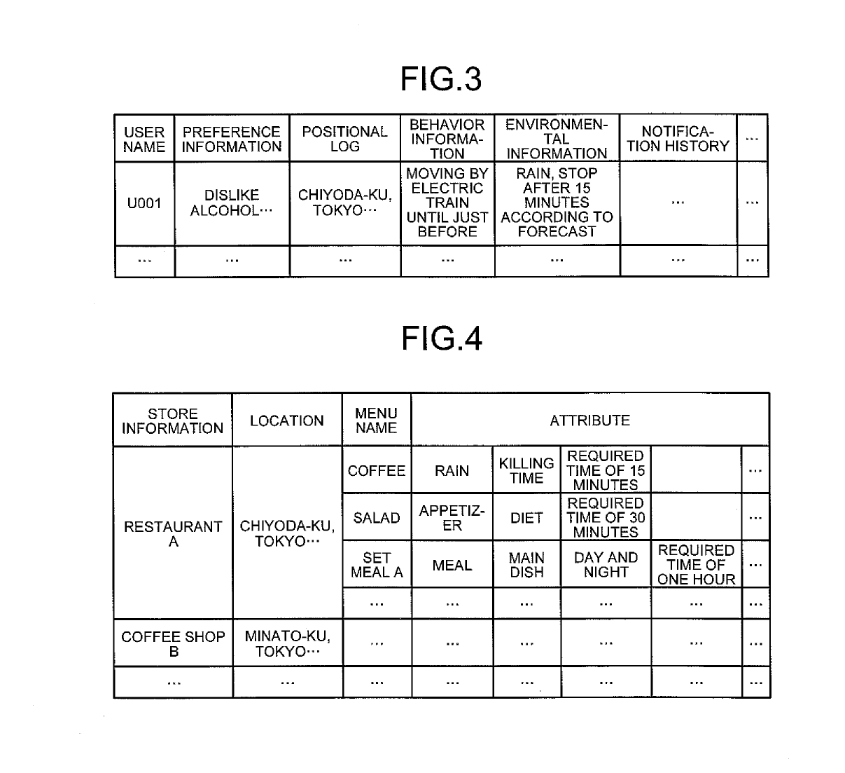

The storage unit 12 is a storage device such as a memory or a hard disk, and holds a user information DB 13 and a menu DB 14. The storage unit 12 stores coupons of respective menus of respective stores in advance. The user information DB 13 is a database that stores the individual information, the positional information, and the like for each registered user. FIG. 3 is a diagram illustrating exemplary information stored in the user information DB.

The user information DB 13 stores “user name, preference information, positional log, behavior information, environmental information, notification history,” and the like as illustrated in FIG. 3. The information mentioned herein is exemplary, and the present invention is not limited to this example. For example, the user information DB 13 may store other service information such as a user name, a user ID, an address, a telephone number, an e-mail address, and a social networking service (SNS) used by the user.

Here, the stored “user name” is information identifying the user such as a name or an ID of the registered user, and is set and registered by the user such as “U001.” The “preference information” is preference information registered by the user and includes information such as “dislike alcohol” or “diet.” The “positional log” is a history of the positional information acquired from the terminal device 1 by a positional information acquiring unit 17 which will be described later, and information such as “ . . . Chiyoda-ku, Tokyo” is stored in time series as the positional log. The “behavior information” is information representing the user's behavior specified by a situation specifying unit 19 which will be described later, and includes information such as “moving by electric train until just before,” “moving by walk,” “moving by car,” “stop,” and “stay.” The “environmental information” is information related to an environment at the current position of the user acquired by an environment acquiring unit 18 which will be described later, and includes information such as “rain, stop after 15 minutes according to forecast,” “shine,” “lots of ultraviolet rays,” and “traffic jam.”

The menu DB 14 is a database that stores a correspondence relation between a menu registered from the store 5 and an attribute. FIG. 4 is a diagram illustrating exemplary information stored in the menu DB. The menu DB 14 stores “store information, location, menu name, attribute” in association with one another as illustrated in FIG. 4.

Here, the stored “store information” is information identifying a registered store such as a store name, and includes a store name such as “restaurant A” or “coffee shop B.” The “location” is information representing a location of a store registered by the store 5 such as “ . . . Chiyoda-ku, Tokyo.” The “menu name” is information which is registered by the store 5 and specifies a menu provided from the store 5 to the user such as “coffee,” “salad,” or “set meal A.”

The “attribute” is information registered for each menu name by the store 5, and includes, for example, information representing a situation in which the user is assumed to use a menu. For example, “menu: coffee” is associated with the attributes “rain, killing time, required time of 15 minutes.” In this case, a situation in which the user gets out of the rain for about 15 minutes is assumed as a situation in which the user drinks a cup of coffee in a restaurant. Further, “menu: salad” is associated with an attributes “appetizer, diet, required time of 30 minutes.” In this case, a situation in which the user orders an appetizer or a diet menu which can be eaten in about 30 minutes is assumed as a situation in which the user orders a salad in a restaurant.

The details of the attribute illustrated herein are merely exemplary, and the present invention is not limited to the illustrated example. For example, for menus having high relevance, one menu may be registered as the attribute of the other menu, and vice versa. For example, the user who has drunk a coffee may order the set meal A later, and the user who has ordered the set meal A may order a coffee. In this case, a menu is stored as an attribute so that the attribute “set meal A” is associated with the menu name “coffee.” The information transmission device plays an advertising role of delivering (transmitting), for example, the menu information or the location of each store which is stored in the menu DB 14 to the user.

Referring back to FIG. 2, the control unit 15 is a processing unit that controls the information transmission device 10 as a whole, such as a processor. The control unit 15 includes a menu receiving unit 16, the positional information acquiring unit 17, the environment acquiring unit 18, the situation specifying unit 19, a matching executing unit 20, and a coupon issuing unit 21.

The menu receiving unit 16 is a processing unit that receives a menu submitted from the store 5 as necessary, and stores the received information in the menu DB 14. For example, the menu receiving unit 16 receives a request to newly register, delete, or update a menu or an attribute, and updates the menu DB 14.

The positional information acquiring unit 17 is a processing unit that acquires the positional information of the user from the terminal device 1 owned by the user. For example, the positional information acquiring unit 17 acquires information of the current position of the terminal device 1 using a global positioning system (GPS), wireless fidelity (Wi-Fi), or an SNS server to which the terminal device 1 is registered when a timing at which matching of the user's situation and an attribute of a menu is performed comes. Then, the positional information acquiring unit 17 stores the acquired positional information of the terminal device 1 in “positional log” of a record of the terminal device 1 in the user information DB 13.

For example, the positional information acquiring unit 17 may acquire information such as a landmark name, an express way, or an electric train assumed from the current position as well as the address representing the current position of the terminal device 1.

The environment acquiring unit 18 is a processing unit that acquires environmental information such as weather, ultraviolet rays, an earthquake, or a traffic jam which corresponds to the positional information of the user. Specifically, upon receiving the current position of the terminal device 1 from the positional information acquiring unit 17, the environment acquiring unit 18 acquires the environmental information corresponding to the current position from an external server or the like, and stores the acquired environmental information in “environmental information” of a record of the terminal device 1 in the user information DB 13.

For example, when “ . . . Chiyoda-ku, Tokyo” is received as the current position, the environment acquiring unit 18 accesses the weather server 4, acquires the weather forecast “rain, stop after 15 minutes” of “Chiyoda-ku, Tokyo,” and stores the acquired weather forecast in the user information DB 13. Further, the environment acquiring unit 18 acquires information of a traffic jam when the current position is “express way,” and acquires a delay status or the like when the current position is an “electric train.”

The situation specifying unit 19 is a processing unit that specifies the user's situation using at least the positional information of the user acquired by the positional information acquiring unit 17. Specifically, the situation specifying unit 19 acquires the “positional log” associated with the terminal device 1 with reference to the user information DB 13 on the terminal device 1, and specifies a behavior history of the terminal device 1 using a positional history of the user, and stores the acquired positional history in the “behavior information” of the user information DB 13. Further, the situation specifying unit 19 specifies the user's situation using the “behavior information,” the “environmental information,” the “preference information,” or the like.

In other words, the situation specifying unit 19 specifies the “behavior information” representing a means that the user has used to move using the “positional log,” and then specifies “the user's situation” that the user is facing. Further, the situation specifying unit 19 need not necessarily use all of the “behavior information,” the “environmental information,” and the “preference information,” and may specify the user's situation using at least the “behavior information.”

For example, when the terminal device 1 is specified to “be at the same place during a certain period of time” based on the “positional log” of the user information DB 13, the situation specifying unit 19 specifies “stay” as the “behavior information.” Further, the situation specifying unit 19 specifies a landmark name “A tower” based on the “positional log,” and acquires “environmental information: shine” stored in the user information DB 13. As a result, the situation specifying unit 19 specifies “stay, A tower, shine” as the user's situation.

The matching executing unit 20 is a processing unit that specifies a menu name having the user's situation specified by the situation specifying unit 19 as an attribute with reference to the menu DB 14. Specifically, the matching executing unit 20 performs matching of the user's situation specified by the situation specifying unit 19 and an attribute of each menu stored in the menu DB 14, and specifies a menu satisfying a certain condition.

At this time, the matching executing unit 20 acquires the current positional information of the terminal device 1, and performs a matching process (which will be described below) using a store within a range of a certain distance from the positional information as a matching target. For example, when the current position is “around 1-chome, Kasumigaseki, Chiyoda-ku, Tokyo,” the matching executing unit 20 sets a store that is located with a 1-km radius or a 5-minute walk from “around 1-chome, Kasumigaseki, Chiyoda-ku, Tokyo” as a matching target.

Here, exemplary matching will be described. For example, when the user's situation is “on electric train until just before, rain, 15 minutes,” the matching executing unit 20 counts the number of attributes that each menu has among “electric train,” “rain,” “15 minutes.” Then, the matching executing unit 20 specifies a menu having two or more attributes as a matching result. Further, when there is no menu having two or more attributes, the matching executing unit 20 determines that there is no matching result.

In addition to the matching technique described herein, various matching techniques used in advertising, images, or the like may be used. For example, the matching executing unit 20 may associate each attribute associated with a menu with “weight” in advance, calculate a score value, and specify a matching result.

For example, an example in which the menu DB 14 stores the attribute “rain (weight 1.8), killing time (0.5), required time of 15 minutes (1.2)” in association with the “menu: coffee” is considered. In this case, the matching executing unit 20 specifies that the “menu: coffee” has “rain (weight 1.8)” and “required time of 15 minutes (1.2)” among the user's situations “electric train, rain, 15 minutes.” Then, the matching executing unit 20 calculates “1.8+1.2=3.0” as the score value of the “menu: coffee.” Then, when the score value is a certain value or more, the matching executing unit 20 specifies the corresponding menu as the matching result.

Further, the matching executing unit 20 may calculate a proportion of the attributes corresponding to the user's situation among the attributes associated with the menu, and specify the matching result.

For example, an example in which the menu DB 14 stores three attributes “rain, killing time, required time of 15 minutes” in association with the “menu: coffee” is considered. In this case, the matching executing unit 20 specifies that the “menu: coffee” has “rain, required time of 15 minutes” as the attribute among the user's situations “electric train, rain, 15 minutes.” Thus, the matching executing unit 20 determines that two of the three attributes associated with the “menu: coffee” match the user's situations. As a result, the matching executing unit 20 calculates “⅔=0.666 . . . ” as the proportion for the “menu: coffee.” Then, when the proportion is a certain value or more, the matching executing unit 20 specifies the corresponding menu as the matching result.

Further, the matching executing unit 20 may extend an attribute associated with a menu using a relevant term or the like and perform matching. For example, when “diet” is associated as the attribute, a relevant term (for example, running) of the diet may be collected from a certain dictionary or the like, the relevant term may be set as the attribute again, and then matching may be performed.

The coupon issuing unit 21 is a processing unit that issues a coupon of a menu specified by the matching executing unit 20 to the terminal device 1. Specifically, upon receiving the matching result from the matching executing unit 20, the coupon issuing unit 21 specifies a coupon corresponding to the matching result and transmits the specified coupon to a target terminal device via an e-mail or the like.

For example, when the matching result for the terminal device 1 is “coffee of restaurant A,” the coupon issuing unit 21 acquires a coupon of “coffee of restaurant A” from the storage unit 12 or a server of the restaurant A. Then, the coupon issuing unit 21 transmits the coupon of “coffee of restaurant A” to the terminal device 1 using the e-mail address of the terminal device 1 stored in the user information DB 13.

### 3. Processing Flow

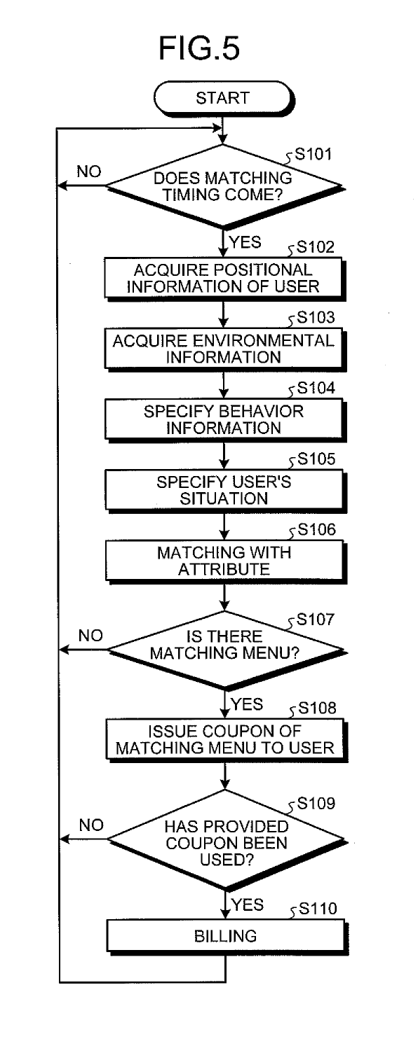

Next, the processing flow of the information transmission device 10 according to the first embodiment will be described. FIG. 5 is a flowchart illustrating the flow of a coupon issuing process performed by the information transmission device according to the first embodiment. Here, the information transmission device 10 is assumed to store menus and attributes in association with each other in advance. The information transmission device 10 performs the process of FIG. 5 on each of registered users, but the description will proceed in connection with an example in which the process of FIG. 5 is performed on the terminal device 1.

As illustrated in FIG. 5, when a matching timing of the terminal device 1 comes (Yes in S101), the positional information acquiring unit 17 of the information transmission device 10 acquires positional information from the terminal device 1 (S102). At this time, the positional information acquiring unit 17 stores the acquired positional information in the “positional log” of the user information DB 13.

Then, when the positional information is acquired by the positional information acquiring unit 17, the environment acquiring unit 18 receives the positional information of the terminal device 1 acquired in S102 from the positional information acquiring unit 17, and acquires environmental information corresponding to the received positional information (S103). At this time, the environment acquiring unit 18 stores the acquired environmental information in the “environmental information” of the user information DB 13.

Thereafter, when it is detected that the positional information or the environmental information is stored in the user information DB 13, the situation specifying unit 19 specifies the user's behavior based on the history of the positional information stored in the user information DB 13 (S104). At this time, the situation specifying unit 19 stores the acquired behavior information in the “behavior information” of the user information DB 13.

Then, the situation specifying unit 19 specifies the user's situation using the “behavior information” and the “environmental information” stored in the user information DB 13 (S105). At this time, the situation specifying unit 19 may further use the “preference information” stored in the user information DB 13. Further, the situation specifying unit 19 outputs the user's specified situation to the matching executing unit 20.

Then, when the user's situation is received from the situation specifying unit 19, the matching executing unit 20 performs matching of the user's situation and the attribute of the menu (S106). At this time, the matching executing unit 20 acquires the current position of the terminal device 1 from the user information DB 13, and extracts a store that is within a certain distance from the current position. Then, the matching executing unit 20 performs the matching process on each extracted store.

Then, when there is no matching menu (No in S107), the process returns to S101, and the subsequent process is repeated. However, when there is a matching menu, the matching executing unit 20 notifies the coupon issuing unit 21 of the matching menu (Yes in S107).

The coupon issuing unit 21 that has been notified of the matching menu acquires a coupon corresponding to the corresponding menu from the storage unit 12 or the store 5, and issues the corresponding coupon to the terminal device 1 using the e-mail address of the terminal device 1 or the like stored in the user information DB 13 (S108).

Thereafter, when the issued coupon is actually used before or on an expiration date (Yes in S109), the coupon issuing unit 21 bills the store in which the coupon has been used (S110). However, when the issued coupon has not been used before or on the expiration date (No in S109), the process returns to S101, and the subsequent process is repeated.

### 4. Concrete Example

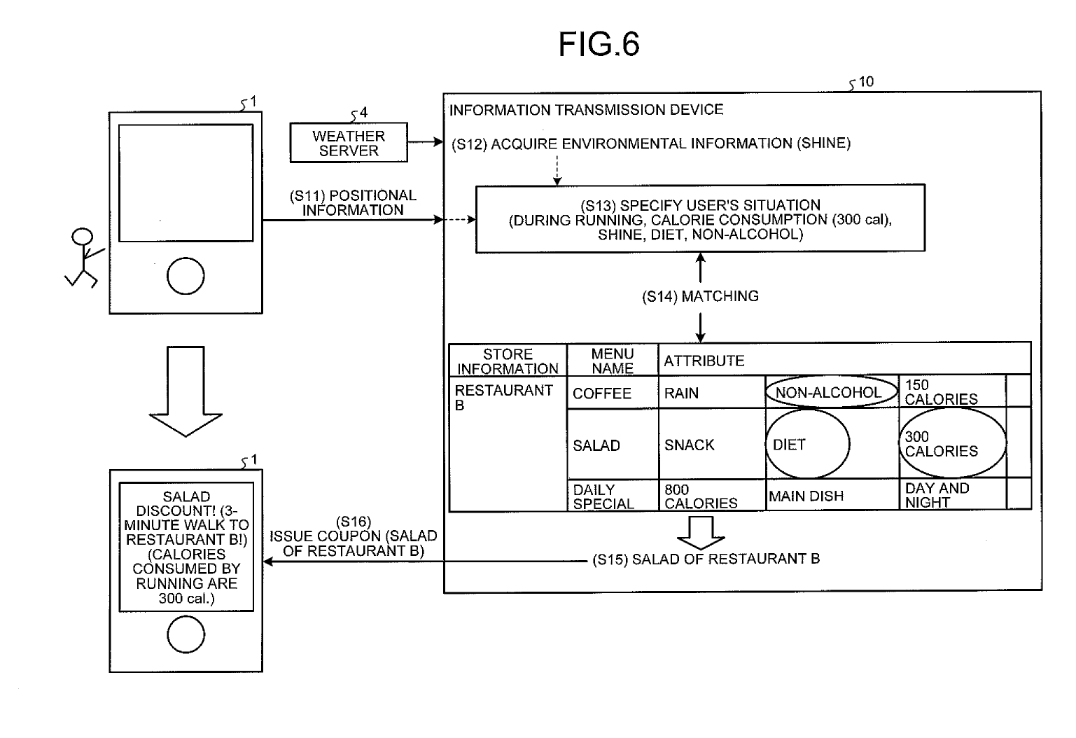

Next, another example other than the above concrete example will be described. FIG. 6 is a diagram for describing of a concrete example of matching. A system configuration illustrated in FIG. 6 is similar to that illustrated in FIG. 1. Here, for convenience of description, a “restaurant B” is assumed as a store within a certain distance from the current position of the terminal device 1.

A point different from that of FIG. 1 lies in that the user of the terminal device 1 is running instead of getting off from the electric train 3. Further, the different point lies in that the information transmission device 10 stores “restaurant B, coffee, rain/non-alcohol/150 calories,” “restaurant B, salad, snack/diet/300 calories,” and “restaurant B, daily special, 800 calories/main dish/date and night” as “store information, menu name, attribute.”

In this state, when the matching timing comes, the positional information acquiring unit 17 of the information transmission device 10 acquires the positional information from the terminal device 1, and stores the positional formation in the user information DB 13 (S11). Further, when the positional information is acquired by the positional information acquiring unit 17, the environment acquiring unit 18 acquires a weather forecast “shine” corresponding to the acquired position from the weather server 4, and stores the acquired weather forecast in the user information DB 13 (S12).

Thereafter, the situation specifying unit 19 specifies the user's situation (S13). Specifically, when “user has moved 1 km for 10 minutes” is specified based on the positional log of the user, the situation specifying unit 19 stores “during running” as the user's behavior information, and stores the user's specified behavior information in the user information DB 13. Further, the situation specifying unit 19 acquires “age, weight, height, body fat,” or the like from the user information previously registered by the user, and calculates “300 cal” as calories consumed by running of “1 km for 10 minutes.” Further, the situation specifying unit 19 acquires “non-drinking, on diet” as preference information from the user information previously registered by the user.

As a result, the situation specifying unit 19 specifies “during running, calorie consumption (300 cal), shine, diet, non-alcohol” as the situations of the user of the terminal device 1 using the behavior information, the environmental information, the preference information, and the like. The calorie consumption may be calculated by the situation specifying unit 19 using a common algorithm.

Then, the matching executing unit 20 performs matching the user's situations “during running, calorie consumption (300 cal), shine, diet, non-alcohol” and the “attribute” of the menu (S14). In this example, the matching executing unit 20 determines that the attribute “non-alcohol” matches for the menu “coffee” of the restaurant B. Further, the matching executing unit 20 determines that the attribute “diet” matches for the menu “salad” of the restaurant B. Further, the matching executing unit 20 determines that there is no matching attribute for the menu “daily special” of the restaurant B.

As a result, the matching executing unit 20 specifies “salad” in which the number of matching attributes is largest and a threshold value or more as the matching result (S15). Thereafter, the coupon issuing unit 21 issues a coupon for the salad of the restaurant B to the terminal device 1 (S16).

### 5. Effects According to First Embodiment

According to the first embodiment, the information transmission device 10 specifies a coupon to be issued using the positional log, the environmental information, the preference information, or the like acquired from the terminal device 1 of the user, and thus the user need not access the server of the store. Thus, it is possible to simplify troublesomeness until the user acquires a coupon.

Further, the information transmission device 10 can acquire the positional log or environment of the user as necessary and follow a change in the behavior or preference of the user, and thus it is possible to deliver a useful coupon at a timing useful for the user and increase the rate of appeals. Further, the information transmission device 10 can deliver a coupon usable at the current position of the user to the terminal device 1 of the user, and thus it is possible to improve the user's desire for coupon use.

Further, when the user is on a diet, the information transmission device 10 can select and deliver a coupon matching the user's preference such as a menu having small calorie consumption or a menu corresponding to calorie consumption, and thus an improvement in a use rate of a coupon can be expected.

Further, as an attribute is allocated to a menu and registered to the information transmission device 10, since it is expected that the user can be induced to visit the store by providing a menu directly to the user, the store 5 updates the menu DB 14. Thus, the update frequency of information provided by the information transmission device 10 increases, and the advertising effect increases as well.

### Second Embodiment

Meanwhile, the first embodiment has been described in connection with the example in which the information transmission device 10 performs the matching process regardless of relevance between menus, but the present invention is not limited to this example. In this regard, the second embodiment will be described in connection with an example in which the matching process is performed in view of relevance between menus.

Specifically, the situation specifying unit 19 of the information transmission device 10 specifies whether there is no change in the positional information of the user even when a certain period of time elapses after a menu is delivered. Then, when the situation specifying unit 19 specifies that there is no change in the positional information of the user even when a certain period of time elapses after a menu is delivered, the matching executing unit 20 specifies a menu having the user's situation specified from the positional information of the user acquired after a certain period of time elapses and relevant information relevant to a coupon of a delivered menu as the attribute with reference to the menu DB 14.

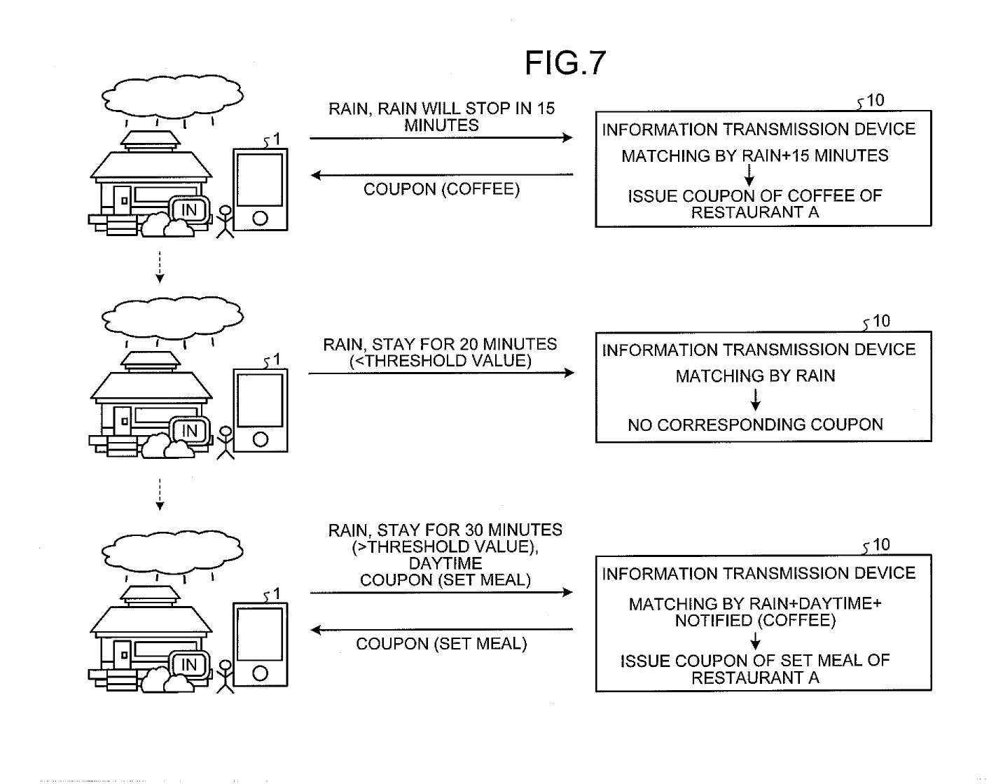

FIG. 7 is a diagram for describing processing of the information transmission device according to the second embodiment. As illustrated in FIG. 7, first of all, the information transmission device 10 acquires the positional information from the terminal device 1 of the user, and specifies that the user is in the restaurant A. Further, the information transmission device 10 acquires “rain” and “stop after 15 minutes” as the weather of the current position of the user. In this case, the information transmission device 10 specifies “coffee” as a menu matching the user's situations “rain” and “15 minutes,” and delivers a coupon of “coffee of restaurant A” to the terminal device 1.

After 20 minutes, the information transmission device 10 acquires the positional information from the terminal device 1 of the user, and specifies that the user is still in the restaurant A. Here, 20 minutes is assumed to be less than a threshold value as a staying time of the user. In this case, the information transmission device 10 delivers no coupon to the terminal device 1 since there is no menu of the restaurant A matching the user's situation “rain.”

Then, after 10 minutes, the information transmission device 10 acquires the positional information from the terminal device 1 of the user, and specifies that the user is still in the restaurant A. Here, 30 minutes is assumed to exceed a threshold value as a staying time of the user. Further, the time is assumed to pass 12:00 during the stay. In this case, the information transmission device 10 decides “rain, daytime, coffee” obtained by adding the coupon “coffee” delivered 30 minutes ago to the user's situations “rain daytime” as the user's situations. Then, the information transmission device 10 specifies “set meal” as a menu matching the user's situations “rain, daytime, coffee,” and delivers a coupon of “set meal of restaurant A” to the terminal device 1. At this time, the information transmission device 10 may deliver various kinds of information used to specify the user's situation such as “3-minute walk to restaurant” or “calorie consumption is 300 cal.”

As described above, according to the second embodiment, it is possible to prevent the same coupon from being delivered several times when there is no change in the user's situation, and thus it is possible to prevent the user's desire of use from decreasing and prevent abuse of a coupon. Further, even when the user stays at a store for a long time, the information transmission device 10 can deliver a different coupon to the user at regular intervals. Thus, for the store side, a menu is likely to be consumed using a coupon, and it is possible to increase a profit. Further, since the store side is expected to check relevance between menus and reset menus as necessary in order to improve the coupon use rate, matching of a coupon capable of increasing the user's desire of use can be expected.

### Third Embodiment

The first and second embodiments have been described in connection with the example in which the user is assumed to behave as an individual, but the present invention is not limited to this example. For example, an example in which an individual first behaves and then a group behaves is considered, and similarly, an example in which a group first behaves and then an individual behaves is also considered.

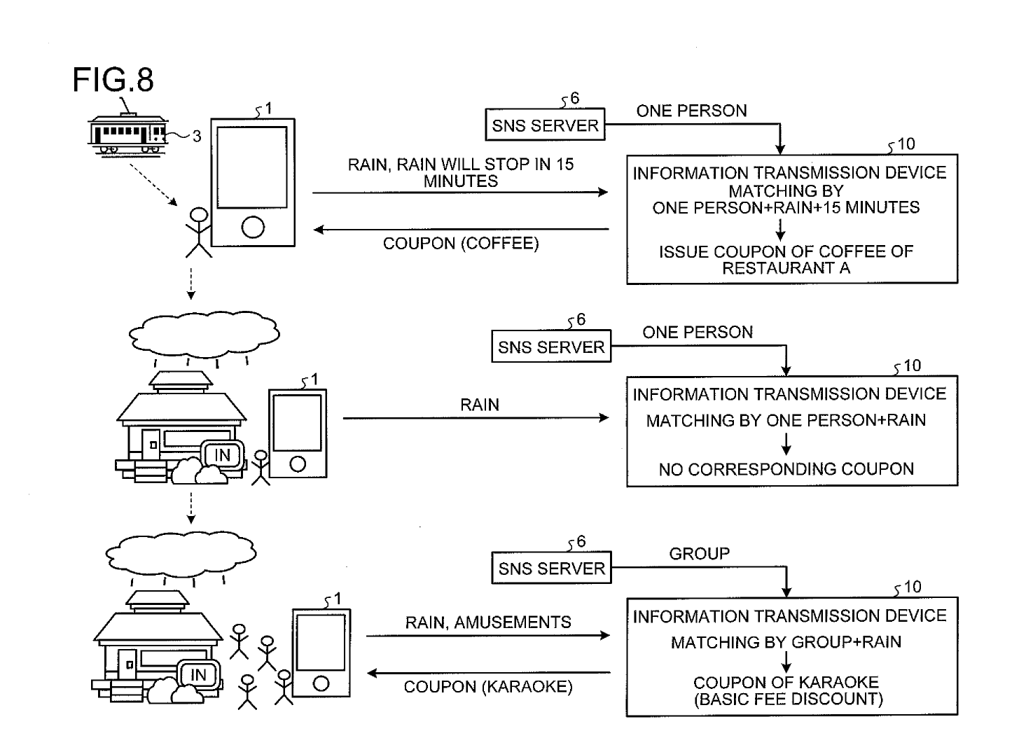

In this regard, a third embodiment will be described in connection with an example in which the user of the terminal device 1 first behaves as an individual and then behaves as a group. FIG. 8 is a diagram for describing processing of an information transmission device according to the third embodiment. Here, for convenience of description, the “restaurant A” is assumed as a store that is within a certain distance from the current position of the terminal device 1.

As illustrated in FIG. 8, first of all, the information transmission device 10 acquires positional information from the terminal device 1 of the user who got off from the electric train 3, and acquires environmental information corresponding to the positional information. Here, the information transmission device 10 specifies “rain, rain will stop after 15 minutes” as the user's situation based on the positional information or the environmental information. Further, the information transmission device 10 accesses an SNS server 6 used by the terminal device 1, and specifies that the user of the terminal device 1 is “one person” using a check-in function. As a result, the information transmission device 10 finally specifies “rain, rain will stop after 15 minutes, one person” as the user's situation.

In this case, the information transmission device 10 specifies “coffee” as a menu matching the user's situations “rain, rain will stop after 15 minutes, one person,” and issues a coupon of “coffee of restaurant A” to the terminal device 1. In other words, the information transmission device 10 specifies a menu matching user's situation from menus or stores associated with an individual.

Then, the information transmission device 10 acquires positional information from the terminal device 1 of the user that has moved to the restaurant A, and acquires environmental information corresponding to the positional information. Here, the information transmission device 10 specifies the user's situation “rain” based on the positional information or the environmental information. Further, the information transmission device 10 accesses the SNS server 6 used by the terminal device 1, and specifies that the user of the terminal device 1 is “one person” using the check-in function or the like. As a result, the information transmission device 10 finally specifies “rain one person” as the user's situation.

In this case, the information transmission device 10 issues no coupon to the terminal device 1 since there is no menu matching the user's situations “rain, one person.”

Thereafter, the information transmission device 10 acquires positional information from the terminal device 1 of the user that is staying in the restaurant A, and acquires environmental information corresponding to the positional information. Here, the information transmission device 10 specifies “rain, amusements” as the user's situation based on the positional information or the environmental information. Further, the information transmission device 10 accesses the SNS server 6 used by the terminal device 1, and specifies that the user of the terminal device 1 has been changed from “one person” to “group” using the check-in function or the like. As a result, the information transmission device 10 finally specifies “rain, amusements, group” as the user's situation.

In this case, the information transmission device 10 specifies “karaoke” as a store matching the user's situations “rain, amusements, group,” and issues a coupon of “basic fee discount of karaoke” to the terminal device 1. In other words, the information transmission device 10 performs the matching process on menus or stores associated with an individual, but when an individual is changed to a group, the information transmission device 10 performs the matching process on menus or stores associated with a group rather than an individual.

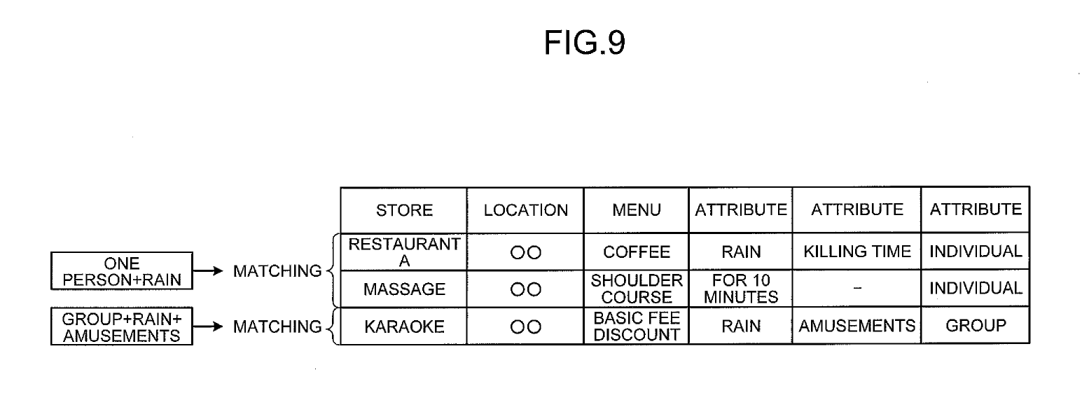

Here, a concrete example in which an individual and a group differ in matching will be described. FIG. 9 is a diagram for describing a first exemplary matching process. As illustrated in FIG. 9, the information transmission device 10 stores “individual” or “group” as one of attributes of each menu of each store. Further, when “one person” is included as the user's situation, the information transmission device 10 performs the matching process using a menu including “individual” as an attribute. Similarly, when “group” is included as the user's situation, the information transmission device 10 performs the matching process using a menu including “group” as an attribute.

In case of FIG. 9, when the user situation is “one person, rain,” the information transmission device 10 selects “restaurant A” and “massage” that have “individual” as an attribute as a matching target, and performs the above-described attribute matching process. Meanwhile, when the user situation is “group, rain, amusements,” the information transmission device 10 selects “karaoke” having “group” as an attribute as a matching target, and performs the above-described attribute matching process.

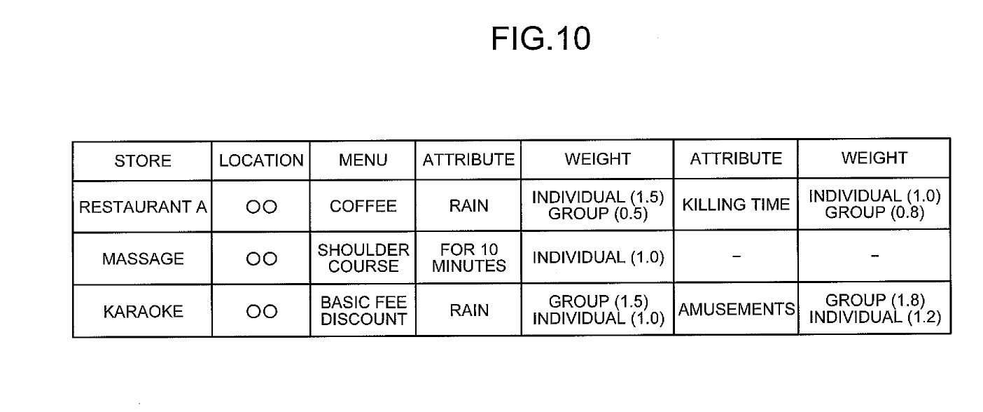

FIG. 10 is a diagram for describing a second exemplary matching process. As illustrated in FIG. 10, the information transmission device 10 stores “weight” with each attribute of each menu for each of an individual and a group. For example, for the attribute “rain” of the menu “coffee”, a weight is “1.5” in case of an individual, and “0.5” in case of a group. It is to distinguish menus for individuals from menus for groups since an individual and a group differ in a selection rate of a menu.

FIG. 10 illustrates an example in which a weight is associated with each attribute, but the present invention is not limited to this example. For example, weighting may be performed for each menu, and weighting may be performed for each store. Further, the score value calculation method or the like described in the first embodiment may be used as the matching process using a weight, and thus a detailed description thereof will be omitted.

As described above, according to the third embodiment, the information transmission device 10 can select the matching target applied to an individual or a group and thus issue a coupon applied to an individual in case of an individual and a coupon applied to a group in case of a group. Thus, a coupon capable of further improving the user's desire of use compared to when an individual is not distinguished from a group can be issued to the user, and thus it is possible to improve the coupon use rate.

Further, even when the number of people who behave as the user is changed, the information transmission device 10 can dynamically change the matching target and follow the user's situation, and thus it is possible to deliver a useful coupon in which the user's situation is appropriately reflected. Further, even when the number of people who behave as the user is changed from an individual to a group, the information transmission device 10 can suppress an unnecessary process such as a process of continuously delivering a coupon corresponding to an individual. Further, the third embodiment has been described in connection with the example in which a change from an individual to group is made, but processing may be performed by a similar technique even when a change from a group to an individual is made.

### Fourth Embodiment

The information transmission device 10 can be implemented in various forms in addition to the first to third embodiments. For example, the above embodiments have been described in connection with a menu of a store, but for example, a similar process can be performed even on a service provided to the user such as a massage. For example, when the user is specified to stay at home for a long time, the information transmission device 10 may issue a coupon such as a discount for posting to an Internet auction.

Further, the second embodiment has been described in connection with the example in which the information transmission device 10 stores a relevant menu as one of attributes, but the present invention is not limited to this example. Specifically, the information transmission device 10 changes a degree of relevance (weight) according to whether an issued coupon has been actually used. For example, the information transmission device 10 may double a weight when a coupon is actually used and then calculate a score value.

Further, “unit” described in the above embodiments may be interpreted as “means,” “section,” “module,” “unit,” “circuit,” or the like. For example, a menu receiving unit may be interpreted as a menu receiving means or a menu receiving circuit.

What is claimed is:

1. An information transmission device, comprising:
a storage unit that stores attribute information of each product to be provided to a user;
an acquiring unit that acquires positional information of the user from a communication device owned by the user;
a situation specifying unit that specifies the user's situation using at least the positional information of the user acquired by the acquiring unit;
an information specifying unit that specifies the product having the user's situation specified by the situation specifying unit as the attribute information with reference to the storage unit; and
a transmitting unit that transmits the product specified by the information specifying unit to the communication device.

2. The information transmission device according to claim 1,
wherein the situation specifying unit specifies whether there is no change in the positional information of the user even when a certain period of time elapses after the product is transmitted to the communication device through the transmitting unit, and
the information specifying unit specifies the product having the user's situation specified based on the positional information of the user acquired by the acquiring unit after the certain period of time elapses and relevant information relevant to the product transmitted by the transmitting unit as the attribute information with reference to the storage unit when the situation specifying unit specifies that there is no change in the positional information of the user even when the certain period of time elapses.

3. The information transmission device according to claim 1,
wherein the situation specifying unit further specifies whether the number of people who behave as the user is an individual or a group, and
the information specifying unit specifies the product having the user's situation as the attribute information among the products corresponding to the number of people specified by the situation specifying unit with reference to the storage unit.

4. The information transmission device according to claim 3,
wherein when the number of people specified by the situation specifying unit is changed from the number of people which is previously specified, the information specifying unit specifies the product having the user's situation as the attribute information among the products corresponding to the changed number of people with reference to the storage unit.

5. The information transmission device according to claim 1,
wherein the situation specifying unit specifies a moving distance and a moving method of the user using the positional information of the user, and calculates calorie consumption that the user has consumed by moving, and
the information specifying unit specifies the product having the calorie consumption calculated by the situation specifying unit as the attribute information with reference to the storage unit.

6. The information transmission device according to claim 1,
wherein the transmitting unit transmits a coupon usable for the product to the communication device of the user, and
the information transmission device further comprises a billing unit that bills a provision source of the service when the coupon is transmitted by the transmitting unit or when the transmitted coupon is used by the user.

7. An information transmission method performed by an information transmission device, comprising:
acquiring positional information of a user from a communication device owned by the user;
first specifying the user's situation using at least the positional information of the user acquired at the acquiring;
second specifying the product having the user's situation specified at the first specifying as attribute information with reference to a storage unit that stores attribute information of each product to be provided to the user; and
transmitting the product specified at the second specifying to the communication device.

8. A non-transitory computer-readable recording medium having stored therein an information transmission program causing a computer to execute a process comprising:
acquiring positional information of a user from a communication device owned by the user;
first specifying the user's situation using at least the positional information of the user acquired at the acquiring;
second specifying the product having the user's situation specified at the first specifying as attribute information with reference to a storage unit that stores attribute information of each product to be provided to the user; and
transmitting the product specified at the second specifying to the communication device.
